(19) United States
(12) Patent Application Publication
(10) Pub. No.: US 2021/0126302 A1
(43) Pub. Date: Apr. 29, 2021

(54) BATTERY MODULE WITH INTEGRATED HEATER

(71) Applicants: Joel Hooper, Waukesha, WI (US); Peter Lex, Menomonee, WI (US); Tod Tesch, Oconomowoc, WI (US)

(72) Inventors: Joel Hooper, Waukesha, WI (US); Peter Lex, Menomonee, WI (US); Tod Tesch, Oconomowoc, WI (US)

(21) Appl. No.: 17/078,290

(22) Filed: Oct. 23, 2020

Related U.S. Application Data
(60) Provisional application No. 62/926,137, filed on Oct. 25, 2019.

(51) Int. Cl. H01M 10/615; H01M 10/6571; H01M 10/63; H01M 10/643; H01M 10/42; H01M 10/44; H02J 7/00

(52) U.S. Cl. CPC H01M 10/615; H01M 10/6571; H01M 10/63; H01M 10/643; H01M 2010/4271; H01M 10/441; H02J 7/0013; H02J 7/0068; H01M 10/425

(57) ABSTRACT

A battery pack includes a heating element, which can be an electric ribbon-type heating element. The heating element can be switched on when pack temperatures are near or fall below the minimum discharge or charge operating temperatures. The heating element can simultaneously function to heat the battery cells and as a separator for a group of cells bound together to form a lightweight battery pack. With such a configuration, the disclosed ribbon-type heater is less prone to damage due to vibration of the battery pack. The heating element can be self-powered by the battery pack cells with DC power or can be externally AC or DC powered. The disclosed heating element is self-contained and controlled by the battery pack BMS. In installations where heating elements are not desired, inactive separator elements can be alternatively provided, thereby reducing costs and avoiding the need to reconfigure other components of the battery pack.

### RELATED APPLICATIONS

This application claims priority to U.S. Provisional Patent Application Ser. No. 62/926,137, filed on Oct. 25, 2019, the entirety of which is incorporated by reference herein.

### BACKGROUND

In cold environments, battery cells, usable in a battery pack or module, have charge and discharge rates that are allowed by cell manufacturers. In part, these limits are based on cell temperature. Keeping the battery cells at a minimum temperature is necessary to maintain the operation of the battery cell storage system. One known approach to maintaining battery cell temperature includes the use of a heat transfer fluid within liquid tubes routed between cells to heat the battery cells. Other known approaches are to provide a heater around the entire battery pack or to provide a heating element within an enclosure containing one or more battery packs. Improvements are desired.

### SUMMARY

This disclosure is directed to systems and methods to providing heating to battery cells of a battery pack. In one example, the heating element is an electric ribbon-type heating element. In one example, the heating element can be switched on when pack temperatures are near or fall below the minimum discharge or charge operating temperatures. In one aspect, the heating element simultaneously functions to heat the battery cells and as a separator for a group of cells bound together to form a lightweight battery pack. With such a configuration, the disclosed ribbon-type heater is less prone to damage due to vibration of the battery pack. For battery pack designs incorporating a heating element acting as a walled separator, such as the disclosed ribbon heater, the heating element can be replaced by plastic inserts when not needed to reduce battery pack cost. In one aspect, the heating element is integrated into cell holder assembly. In one aspect, the heating element can be self-powered by the battery pack cells with DC power. The heating element can also be externally AC or DC powered. The disclosed heating element is self-contained and controlled by the battery pack BMS or system level BMS. In installations where heating elements are not desired, separator elements can be alternatively provided, thereby reducing costs and avoiding the need to reconfigure other components of the battery pack.

In one example, a battery pack includes a first battery holder frame and a second battery holder frame, a plurality of battery cells secured between the first and second battery holder frames, and at least one electric heating element secured between and in direct physical contact with the first and second battery holder frames, the at least one electric heating element being in direct contact with each of the plurality of battery cells.

In some examples, the heating element is powered by the plurality of battery cells.

In some examples, the battery pack includes a battery management system controlling charging and discharging of the battery pack, wherein the battery management system further controls the heating element operation.

In some examples, the battery holder frame includes a first plurality of cylindrically-shaped sidewalls securing the battery cells at one end and a second plurality of cylindrically-shaped sidewalls securing the battery cells at the opposite end.

In some examples, the heating element is located between an first inner end of the first plurality of cylindrically-shaped sidewalls and a second inner end of the second plurality of cylindrically-shaped sidewalls.

In some examples, each of the first and second holders include opposing separator walls extending along sides of the battery cells and forming a gap therebetween.

In some examples, the heating element includes a plurality of heating elements.

In some examples, some of the plurality of battery cells are oppositely arranged with respect to others of the plurality of battery cells.

In some examples, the heating element is a single continuous heating element.

In one example, a battery pack includes a first battery holder frame including a first plurality of cylindrically-shaped sidewalls defining a first plurality of openings, a second battery holder frame including a second plurality of cylindrically-shaped sidewalls defining a second plurality of openings, a plurality of battery cells secured between the first and second battery frames, such that a first end of each of the plurality of battery cells is received in one of the first plurality of openings and such that a second end of each of the plurality of battery cells is received in one of the second plurality of openings, an interstitial space extending between the plurality of battery cells and between a first inner end of the first plurality of cylindrically-shaped sidewalls and a second inner end of the second plurality of cylindrically-shaped sidewalls, and a heating arrangement including at least one heating element positioned within the interstitial space, wherein a width of the heating element is generally equal to a first distance between the first and second inner ends.

In some examples, the first inner end is in contact with a first side edge of the at least one heating element and the second inner end is in contact with a second side edge of the at least one heating element.

In some examples, the at least one heating element is in contact with each of the plurality of battery cells.

In some examples, the first battery holder frame further includes a plurality of first support wall extensions extending from at least some of the first plurality of openings in a direction towards the second battery holder frame.

In some examples, the at least one heating element extends between the plurality of first support wall extensions such that each battery cell is supported on one side by the at least one heating element and on an opposite side by one of the plurality of first support wall extensions.

In some examples, the second battery holder frame further includes a second plurality of support wall extensions extending from at least some of the second plurality of openings in a direction towards the first battery holder frame, wherein each battery cell is supported on one side by one of the plurality of second support wall extensions

In some examples, the battery pack also includes a power and control system configured to charge and discharge the battery cells and to control power delivered to the at least one heating element.

In one example, a method of assembling a battery pack includes providing an enclosure, installing a first holder within the enclosure, inserting a plurality of battery cells within the first holder, inserting at least one heating element between the battery cells, installing a second holder over the plurality of batteries and the heating element such that the heating element is clamped between the first and second holders, and covering the enclosure.

In some examples, the inserting a heating element step includes inserting the heating element such that the at least one heating element contacts each of the plurality of battery cells.

In some examples, the inserting a heating element step includes inserting the heating element between the plurality of battery cells along every other row of battery cells.

In some examples, after the step of installing a second holder, the at least one heating element is in direct physical contact with the first and second holders.

A battery pack can include a first battery holder frame including a first plurality of cylindrically-shaped sidewalls defining a first plurality of openings, a second battery holder frame including a second plurality of cylindrically-shaped sidewalls defining a second plurality of openings, a plurality of battery cells secured between the first and second battery frames, such that a first end of each of the plurality of battery cells is received in one of the first plurality of openings and such that a second end of each of the plurality of battery cells is received in one of the second plurality of openings, an interstitial space extending between the plurality of battery cells and between a first inner end of the first plurality of cylindrically-shaped sidewalls and a second inner end of the second plurality of cylindrically-shaped sidewalls, and a separator that is separately formed from the first and second battery holder frames, the separator being positioned within the interstitial space and having a first side in contact with at least one of the plurality of battery cells and a second side in contact with at least one other of the plurality of battery cells, wherein the separator is one of an electric heating element and an inactive insert component. In some examples a width of the heating element and/or the inactive insert component is equal to height of the interstitial space between the battery holder frames.

### BRIEF DESCRIPTION OF THE DRAWINGS

FIG. 1 is a perspective view of an example battery pack having features in accordance with the present disclosure.

FIG. 2 is an exploded perspective view of the battery pack shown in FIG. 1.

FIG. 3 is an exploded side view of the battery pack shown in FIG. 1.

FIG. 4 is a cross-sectional side view of the battery pack shown in FIG. 1.

FIG. 5 is a first end view of the battery pack shown in FIG. 1, with a second cover and a second battery holder frame removed such that battery cells and heating elements of the battery pack can be viewed.

FIG. 6 is a second end view of the battery pack shown in FIG. 1, showing only the second battery holder frame and the heating elements.

FIG. 7 is a perspective view of the portion of the battery pack shown in FIG. 6.

FIG. 8 is a perspective view of a first battery holder frame of the battery pack shown in FIG. 1.

FIG. 9 is an end view of the first battery holder frame shown in FIG. 8.

FIG. 10 is a side view of the first battery holder frame shown in FIG. 8.

FIG. 11 is a cross-sectional side view of the first battery holder frame shown in FIG. 8.

FIG. 12 is a cross-sectional perspective view of the first battery holder frame shown in FIG. 8.

FIG. 13 is a perspective view of a second battery holder frame of the battery pack shown in FIG. 1.

FIG. 14 is an end view of the second battery holder frame shown in FIG. 13.

FIG. 15 is a side view of the second battery holder frame shown in FIG. 13.

FIG. 16 is a cross-sectional side view of the first battery holder frame shown in FIG. 13.

FIG. 17 is a cross-sectional perspective view of the first battery holder frame shown in FIG. 13.

FIG. 18 is a perspective view of a heating arrangement of the battery pack shown in FIG. 1.

FIG. 19 is a side view of the heating arrangement shown in FIG. 18.

FIG. 20 is an end view of the heating arrangement shown in FIG. 18.

FIG. 21 is a perspective view of a separator arrangement of the battery pack shown in FIG. 1.

FIG. 22 is a side view of the separator arrangement shown in FIG. 21.

FIG. 23 is an end view of the separator arrangement shown in FIG. 21.

FIG. 24 is an exploded perspective view of a portion of the battery pack shown in FIG. 1 showing an alternative arrangement in which separators are utilized instead of heating elements.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The importance of distributed energy storage is increasing rapidly, due to the growth of solar and other distributed energy technologies, which have become a significant source of energy on electric grids worldwide. As energy storage becomes a key part of grid technology, cost-effective battery storage that is capable of performing multiple charge/discharge cycles per day is becoming increasingly important. Further, as millions of storage units are deployed, it will be valuable to reduce the cost and complexity of these systems, and to provide battery packs capable of functioning in a wide range of operating environments.

Electric grids and the use of distributed energy storage devices would benefit from a simple, cost-effective modular energy storage battery product that is fast and simple to install, physically compact, and capable of delivering multiple charge/discharge cycles per day, without the complexity of liquid cooling or other special techniques.

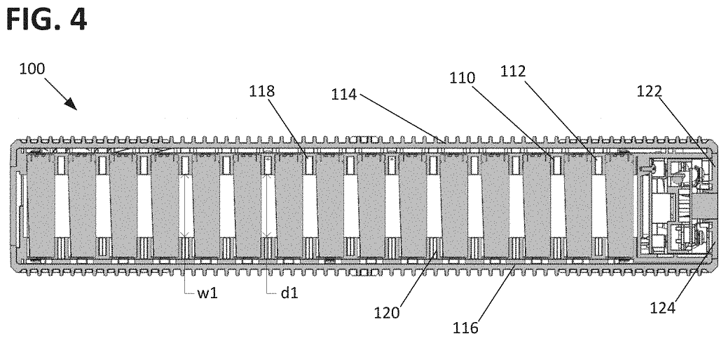

In one aspect, the disclosure includes systems and methods providing a way to maintain operational-range cell temperatures in a battery module 100 while maintaining the safety features of the battery module 100. For example, and as explained in further detail below, the battery module 100 includes a heating arrangement and related constructions for maintaining the temperature of a plurality of cells 102, such as cylindrical 18650 or 21700-type lithium cells. As indicated at FIG. 4, the cells 102 have a length 11 which can vary by the type of cell. Common lengths for 11 are 65 mm (millimeters) and 70 mm.

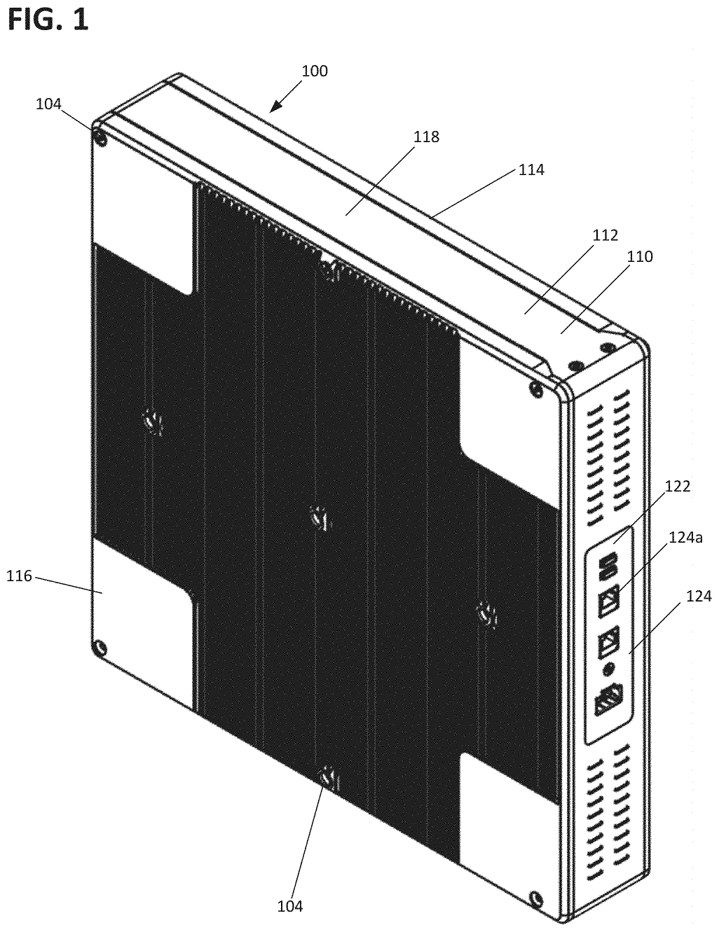

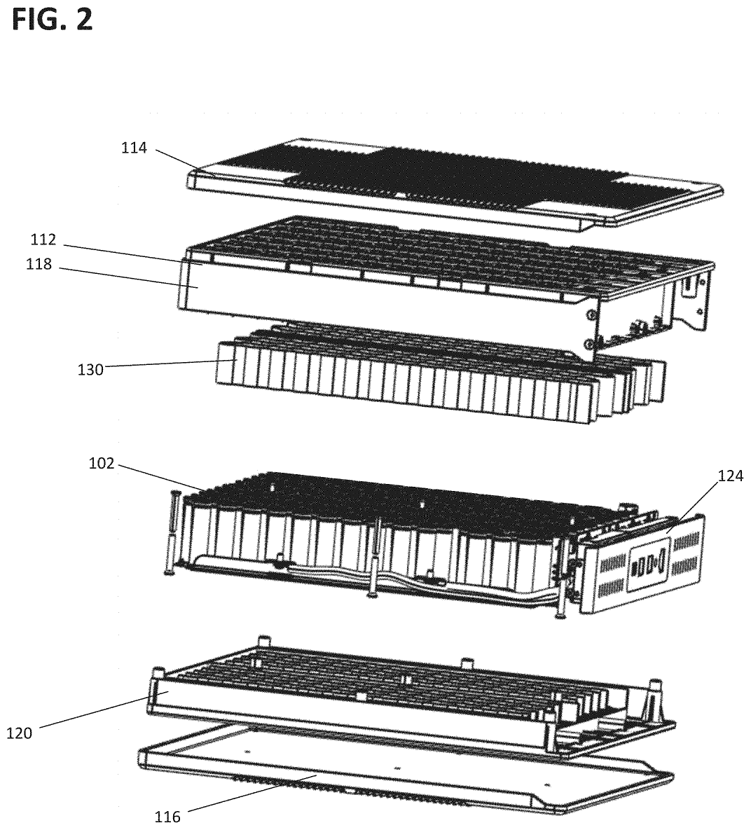

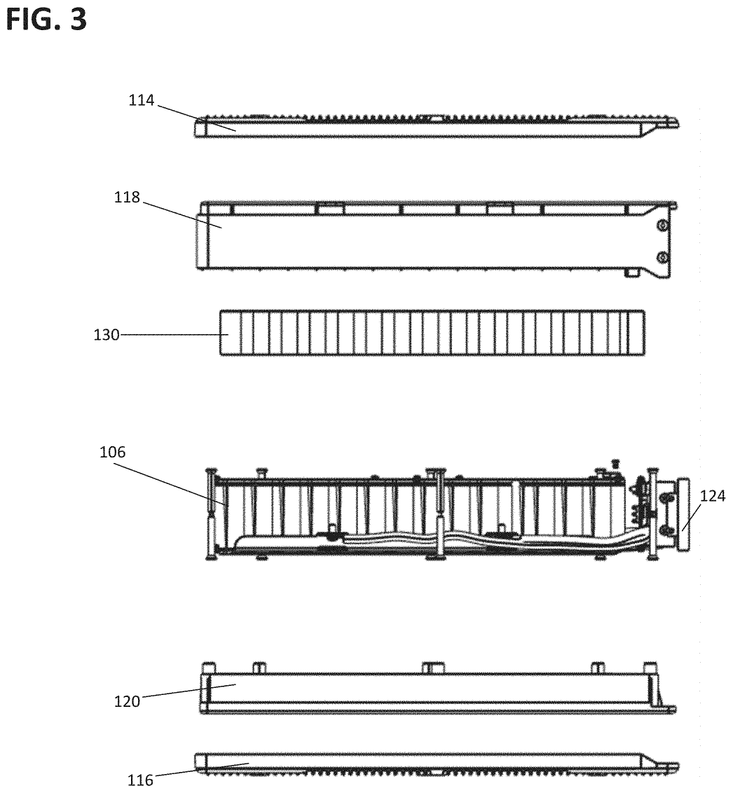

Referring to FIGS. 1 to 4, an example battery module 100 is presented. The battery module 100 may also be referred to as a smart battery or a battery pack 100. As shown, the battery module 100 includes a plurality of battery cells 102 secured within a housing 110, which can include, for example, a chassis 112 and a pair of covers 114, 116. In one aspect, and as most easily seen at FIGS. 2 to 4, the chassis 112 can be formed by a first battery holder frame 118 and a second battery holder frame 120. The battery holder frames 118, 120 are oppositely facing such that the battery cells 102 are secured in place between the battery holder frames 118, 120 in a fixed position. In one aspect, the battery pack 100 can include various fasteners 104, such as screws or bolts, that extend between the covers 114, 116 and through the battery holder frames 118, 120 to secure the entire assembly together.

As illustrated, a power and control system 122 including a head module 124 is secured to the chassis 112 between the covers 114, 116 and is shown as partially forming a face of the battery module 100. Accordingly, the control head module 124 can be characterized as forming a portion of the housing 110. In one aspect, the power and control system 122 can include electronics, for example a processor and memory within the head module 124, for controlling charging and discharging of the battery cells 102 and interfacing with external equipment, such as solar panels. The control head module 124 is also shown as including a plurality of ports and jacks 124a for accomplishing such purposes. As discussed in more detail below, the battery pack 100 further includes a heating arrangement 130 configured to regulate and/or maintain the temperature of the battery cells 102. In one aspect, the heating arrangement is powered and controlled by the power and control system 122. It is noted that the power and control system 122 also includes numerous other components not shown or described herein, but that are well understood by a person having skill in the art, as they do not relate specifically to the focus of this disclosure. For example, the battery pack 100 includes lead plates and additional components for electrically connecting the battery cells 102 together such that power can be delivered to and from the battery cells 102, and to and from the battery pack 100.

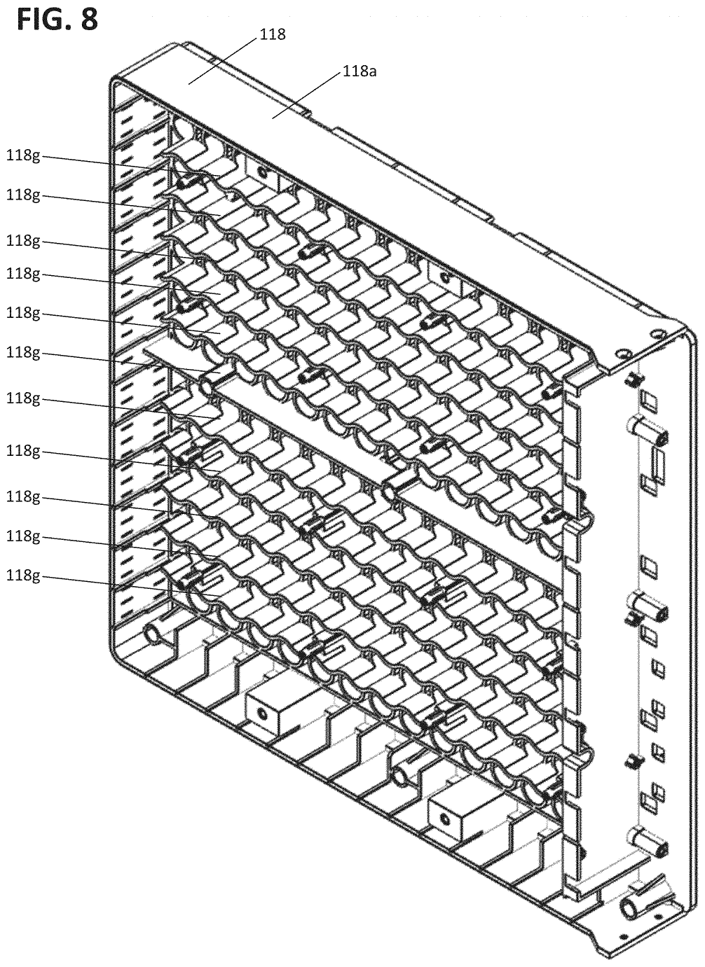

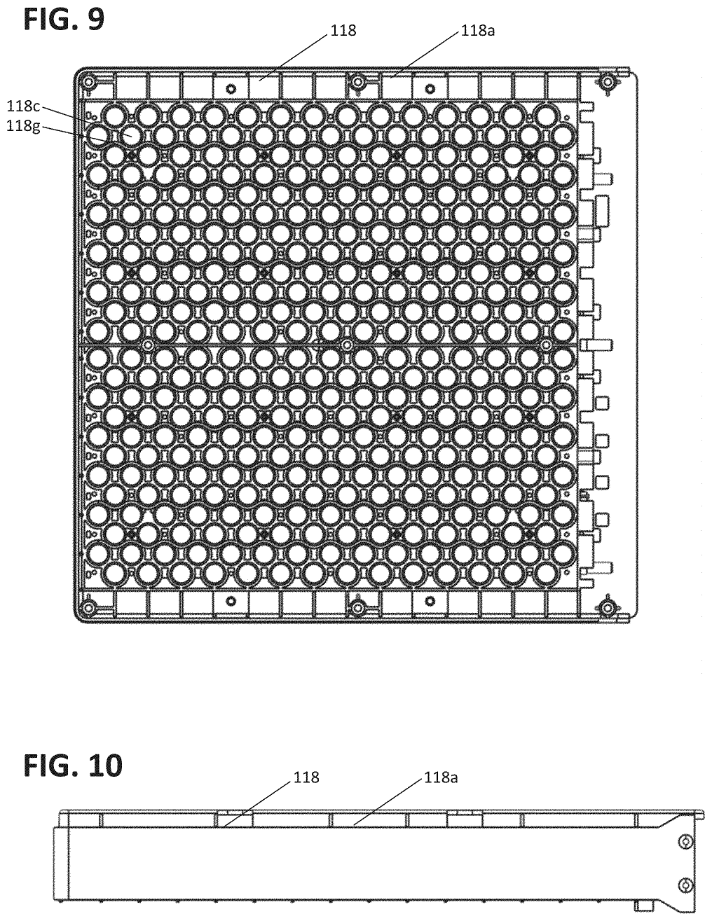

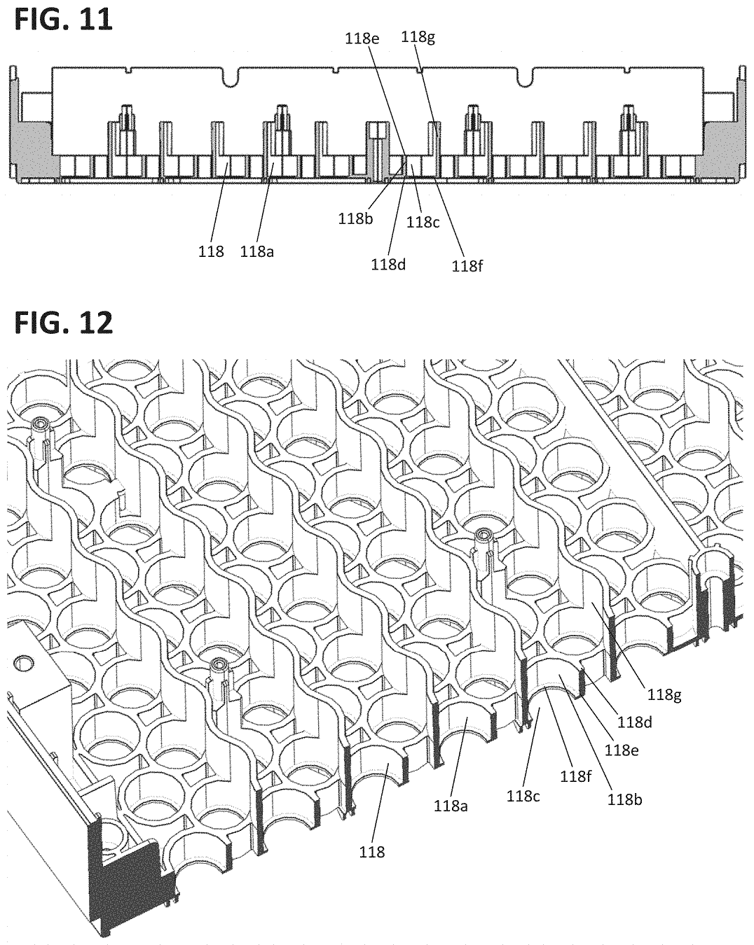

With reference to FIGS. 8 to 12, the first battery holder frame 118 is shown in isolation. As presented, the first battery holder frame 118 is unitarily formed as a main body 118a. In some examples, the main body 118a is formed from a polymeric material, such as an injection molded plastic material. In one aspect, the main body 118a is provided with an array of adjoining, staggered cylindrically-shaped sidewalls 118b defining openings 118c for receiving ends of the battery cells 102. The openings 118c have a dimension that is roughly equal to the diameter of the battery cells 102, thereby enabling the sidewalls 118b to provide support to the sides of the battery cells 102. The sidewalls 118b extend between a first end 118d and a second end 118e to define a height h1 of about, for example, 10 mm. At the second end 118e of each sidewall 118b, an end or flange wall 118f is provided that extends orthogonally from the sidewall 118b and into the corresponding opening 118c. As configured, each wall 118f reduces the dimension of the opening 118c to less than the diameter of the battery cell 102 such that the flange wall 118f provides support to an end of the battery cell 102 while preventing the battery cell 102 from passing entirely through the opening 118c at the second end 118e. In the particular example shown, the first battery holder frame 118 is provided with 348 openings 118c, arranged in 24 rows, for receiving a corresponding number of battery cells 102. However, more or fewer openings 118c may be provided.

In one aspect, the first battery holder frame 118 is provided with a plurality of support wall extensions 118g extending along a portion of each of the sidewalls 118b such that the openings 118c are divided into rows of two between each extension 118g. The extensions 118g are provided with an alternating curved or serpentine profile matching the curvature of the sidewalls 118b. Accordingly, the support wall extensions 118g form a continuous portion or extension of the sidewalls 118b and extend the effective length of one side of each of the sidewalls 118b. With such a configuration, the battery cells 102 are provided with additional lateral support and separation between the battery cells 102 is maintained. In some examples, the support wall extensions 118g can have a straight shape rather than an undulating shape, as is depicted for the center support wall extension 118g, where it can be seen that the openings on either side of the extension 118g are directly opposite each other rather than being staggered. In the particular example shown, the first battery holder frame 118 is provided with 348 openings 118c for receiving a corresponding number of battery cells 102. In the particular example shown, ten undulating support wall extensions 118g and one straight support wall extension 118g are provided. However, more or fewer straight or undulating support wall extensions 118g may be provided.

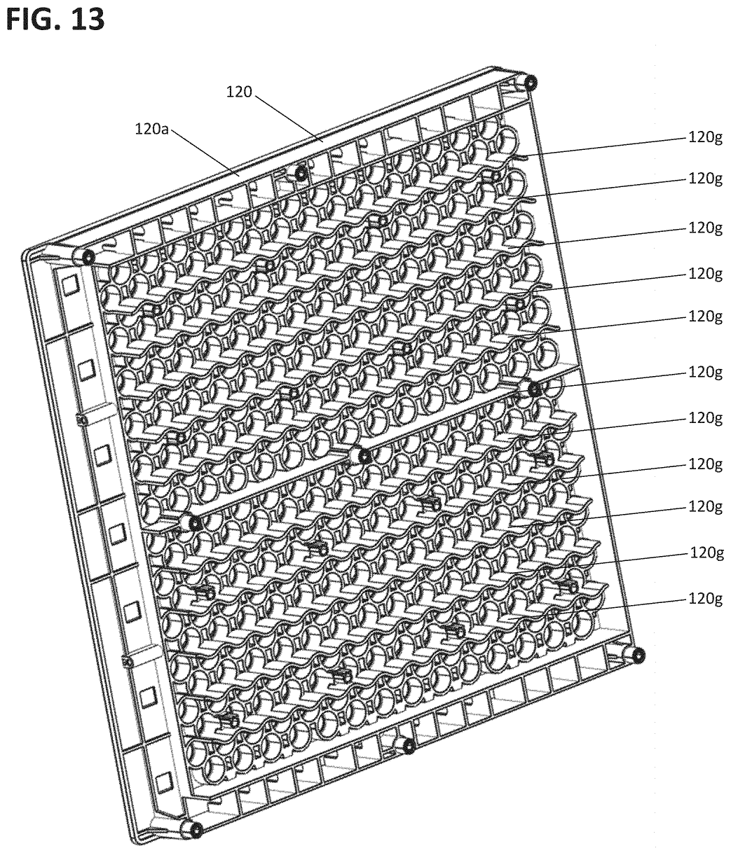

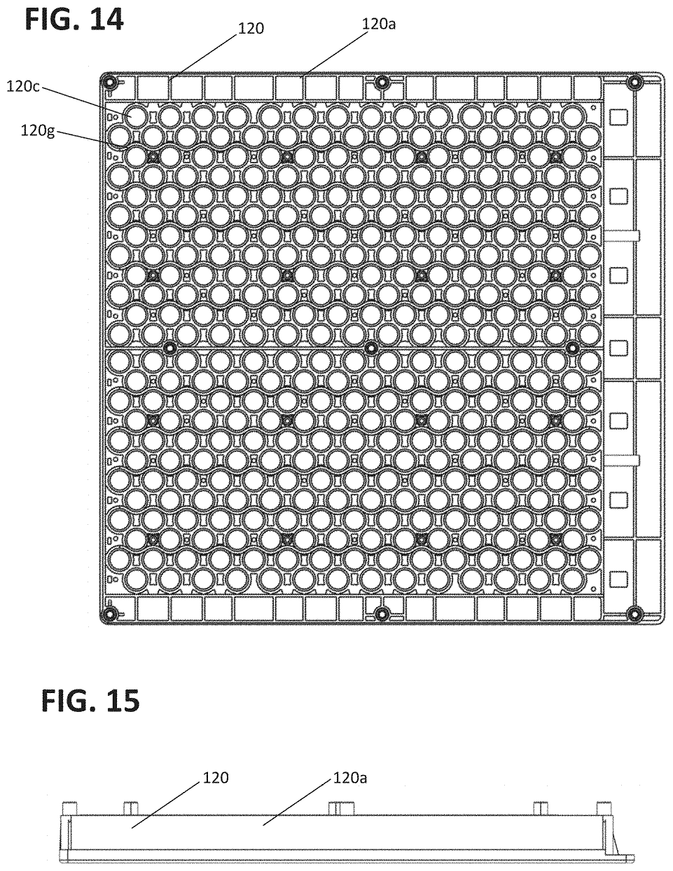

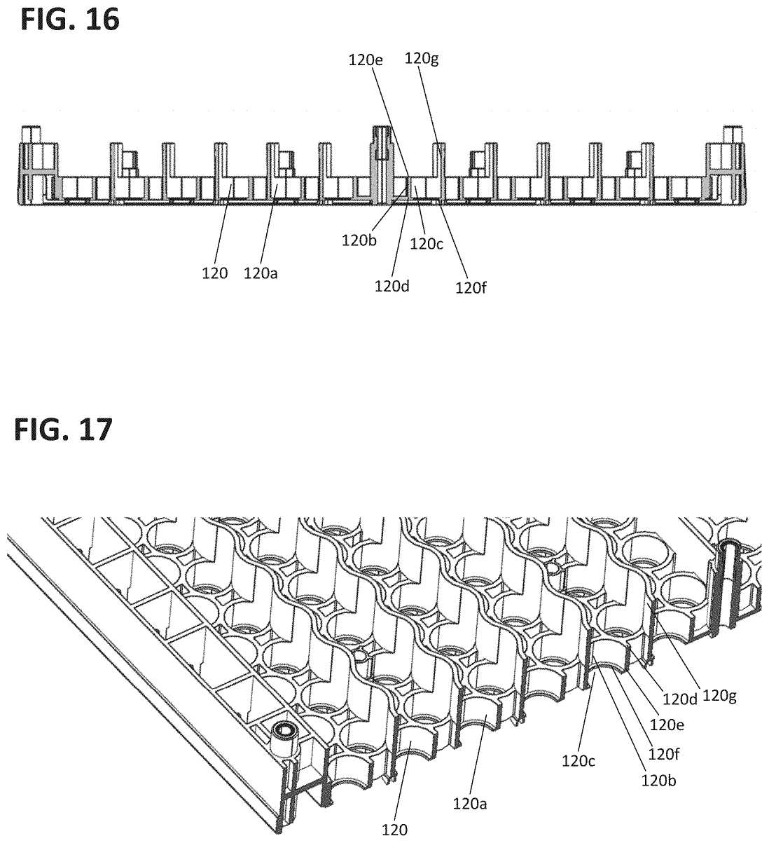

With reference to FIGS. 13 to 17, the second battery holder frame 120 is shown in isolation. As presented, the second battery holder frame 120 is unitarily formed as a main body 120a. In some examples, the main body 120a is formed from a polymeric material, such as an injection molded plastic material. In one aspect, the main body 120a is provided with an array of adjoining, staggered cylindrically-shaped sidewalls 120b defining openings 120c for receiving ends of the battery cells 102. The openings 120c have a dimension that is roughly equal to the diameter of the battery cells 102, thereby enabling the sidewalls 120b to provide support to the sides of the battery cells 102. The sidewalls 120b extend between a first end 120d and a second end 120e to define a height h2 of about, for example, 10 mm. In the example shown, the heights h1 and h2 are equal but may be provided with differing values. At the second end 120e of each sidewall 120b, an end or flange wall 120f is provided that extends orthogonally from the sidewall 120b and into the corresponding opening 120c. As configured, each wall 120f reduces the dimension of the opening 120c to less than the diameter of the battery cell 102 such that the flange wall 120f provides support to an end of the battery cell 102 while preventing the battery cell 102 from passing entirely through the opening 120c at the second end 120e. In the particular example shown, the second battery holder frame 120 is provided with the same number of openings 120c and arrangement as that provided for the battery holder frame 118, albeit in a mirrored configuration. Accordingly, the second battery holder frame 120 is provided with 348 openings 120c, arranged in 24 rows, for receiving a corresponding number of battery cells 102. However, more or fewer openings 120c may be provided.

In one aspect, the second battery holder frame 120 is provided with a plurality of support wall extensions 120g extending along a portion of each of the sidewalls 120b such that the openings 120c are divided into rows of two between each extension 120g. The extensions 120g are provided with an alternating curved or serpentine profile matching the curvature of the sidewalls 120b. Accordingly, the support wall extensions 120g form a continuous portion or extension of the sidewalls 120b and extend the effective length of one side of each of the sidewalls 120b. With such a configuration, the battery cells 102 are provided with additional lateral support. In some examples, the support wall extensions 120g can have a straight shape rather than an undulating shape, as is depicted for the center support wall extension 120g, where it can be seen that the openings on either side of the extension 120g are directly opposite each other rather than being staggered. In the particular example shown, there second battery holder frame 120 is provided with 348 openings 120c for receiving a corresponding number of battery cells 102. In the particular example shown, ten undulating support wall extensions 120g and one straight support wall extension 120g are provided, which is the same as that provided for the first battery holder frame 118. However, more or fewer straight or undulating support wall extensions 120g may be provided.

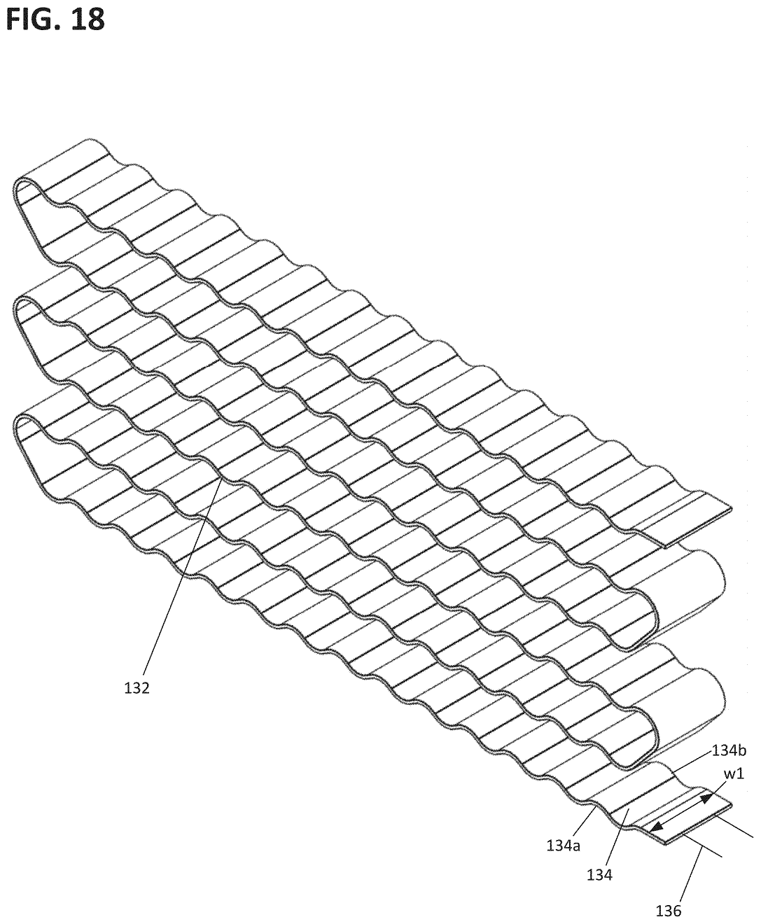

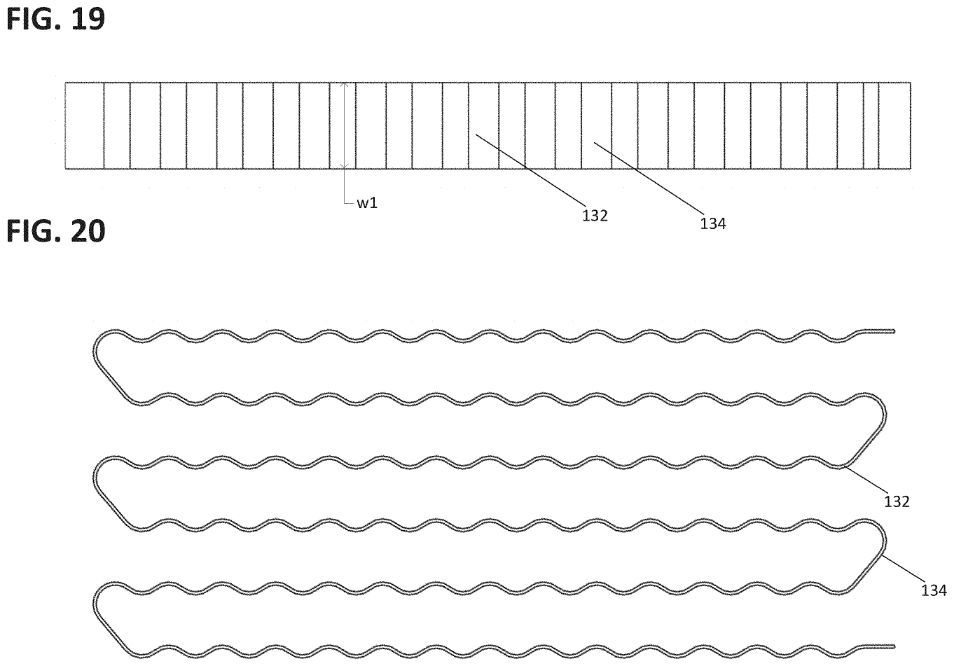

With reference to FIGS. 18 to 20, a heating element 132 of the heating arrangement 130 is shown in isolation. In the depicted example, two heating elements 132 are provided in the battery pack 100. Alternatively, a single, longer heating element 132 may be provided or multiple shorter heating elements 132 may be provided. In the example shown, the heating element 132 is a ribbon-type electric heating element including a substrate or base material 134 within which one or more resistive elements (e.g. wires, soldering, etc.) 136 are embedded. In one aspect, the ribbon 134 extends between side edges 134a, 134b to define a width w1, for example a width w1 of about 25 to 75 millimeters (mm). In one example, the width w1 is about 50 mm. In some examples, the substrate 134 has a thickness of between 0.2 and 0.5 mm. In some examples, the substrate 134 is a polymide film or tape (e.g. KAPTON tape). Other materials, such as silicone-based materials and laminated foils, may also be used depending upon application. In some examples, the substrate 134 can be provided with an adhesive that is bonded to the battery cells 102 after installation. In some examples, the heating element 132 has a heating or power density of about 0.5 watts per square centimeter. One particular example of a heating element suitable for use with the disclosed invention is a Hotlong HL-00368(a)-E-O from Jiangyin Electric Heating Appliance Ci., Ltd., China. In one aspect, the substrate or base material 134 is flexible such that the material 134 can be routed between and conform to the shape of the walls of the battery cells 102. Alternatively, the substrate or base material 134 can be pre-formed to have the depicted undulating or serpentine shape before installation into the battery pack 100. In some examples, the heating elements 132 are powered by the battery cells 102 of the battery pack 100. In some examples, the heating elements 132 are powered by an external AC or DC power source. With either approach, the output of the heating elements 132 can be powered through and controlled by the power and control system 122, for example via the head module 124.

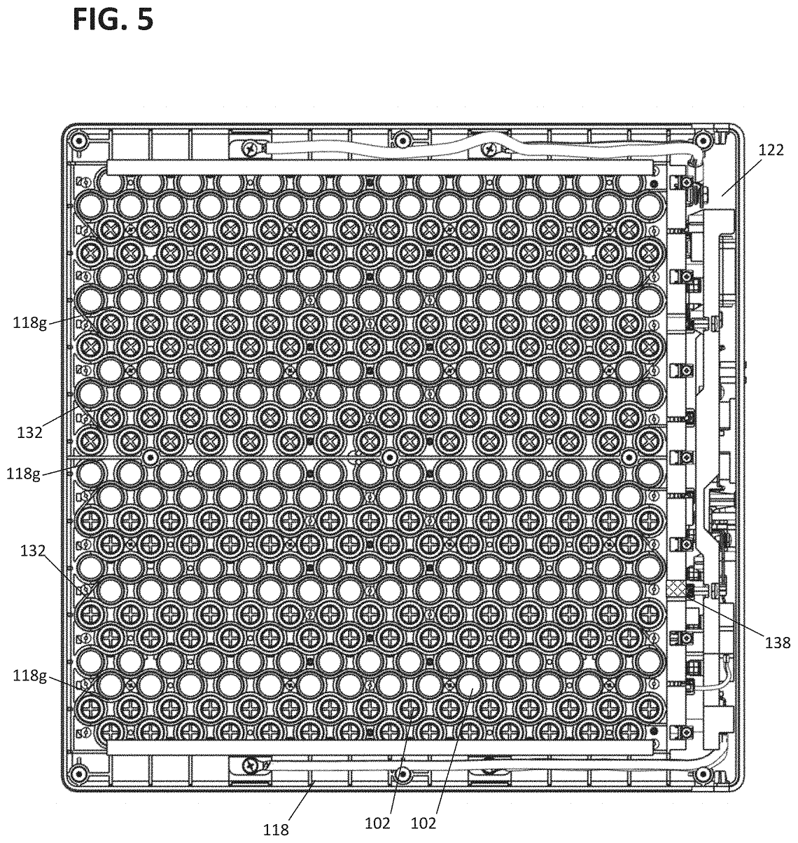

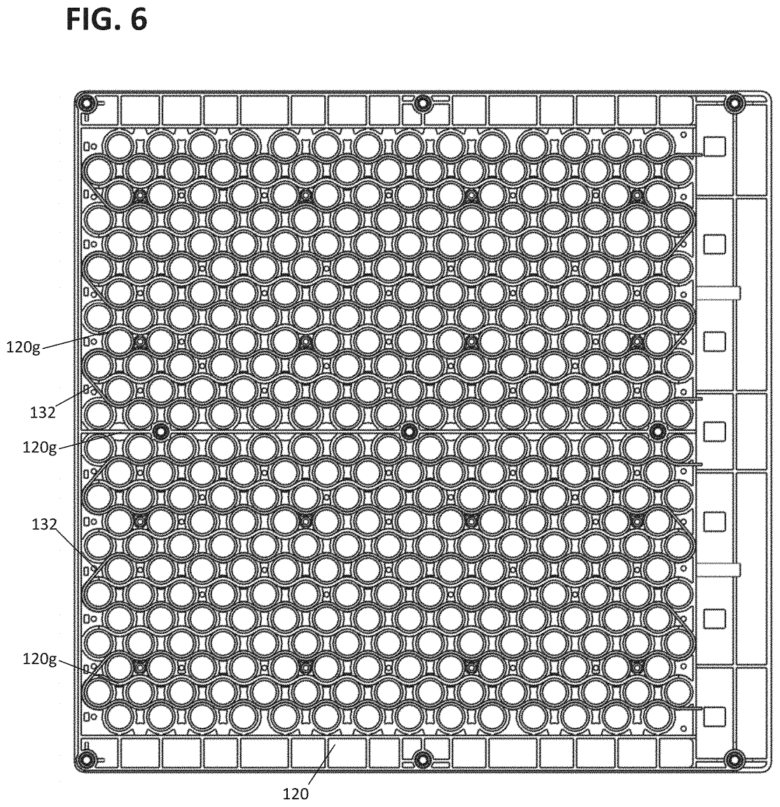

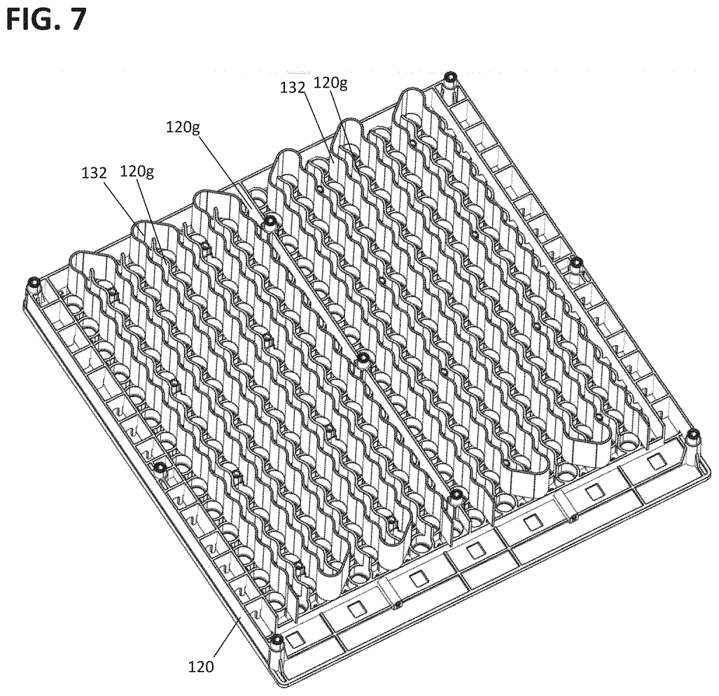

As most easily viewed at FIGS. 4 to 7, the heating elements 132 are routed between adjacent rows of battery cells 102 and positioned between the first battery holder frame 118 and the second battery holder frame 120. With such an arrangement, and as most easily seen at FIG. 5, one side of each battery cell 102 in the battery pack 100 is in direct contact with a heating element 132. Accordingly, heat from the heating arrangement 130 is evenly directed to all of the battery cells 102 throughout the battery pack 100. As most easily viewed at FIG. 7, the heating elements 132 are routed along the openings 120c (and 118c) on a side opposite that of the support wall extensions 120g (and 118g). With such a configuration, the heating elements 132 perform an additional function of laterally supporting and securing the battery cells 102 within the battery holder frames 118, 120 such that each battery cell 102 is supported on one side by a support wall extension 118g, 120g and on the opposite side by a portion of the heating element 132. This configuration also allows the heating elements 132 to perform a separator function to maintain separation between the rows of battery cells 102. As can be seen at FIG. 5, the lateral gaps or interstitial spaces that exist between the battery cells 102, due to the thickness of the sidewalls 118b, 120b are filled by a support wall extension 118g, 120g on one side of each battery cell 102 and by a portion of the heating element 132 on the opposite side of each battery cell 102. Accordingly, the support wall extensions 118g, 120g and the heating elements 132 together function to laterally support the battery cells 102 within the battery pack 100.

As most easily seen at FIG. 4, the heating elements 132 are secured or clamped between the battery holder frames 118, 120 such that the heating element 132 is held in a stable position in a direction parallel to the lengths 11 of the battery cells 102. In one aspect, the width w1 of the heating elements 132 is generally equal to a resulting gap or distance d1 of an interstitial space extending between the sidewall ends 118d, 120d. In the example presented, the distance d1 is generally the length 11 of the battery cells 102 minus the sum of the heights h1, h2 of the holder frames 118, 120. As used, the terms “generally equal to” means that the width w1 is between 90% and 100% of the distance d1. In some examples, the width w1 is at least half the distance d1. In the example shown, the width w1 and the distance d1 are similar enough such that the ends 118d, 120d of the frames 118, 120 abut the side edges 134a, 134b of the heating elements 132, thereby fully securing the heating elements 132 in place. With such a configuration, heat generated by the heating elements 132 is efficiently contained about the battery cells 102, as the battery holder frames 118, 120, in cooperation with the heating elements 132, effectively form a closed environment around the battery cells 102, with the exception of the terminal ends of the battery cells 102. Accordingly, the disclosed design can more efficiently maintain the desired temperature of the battery cells 102 with less energy input. In some examples, the battery pack 100 can be heated with heating elements 132 that draw 100 watts or less.

In operation, the power and control system 122 can power and control the heating arrangement 130. The heating element 132 can be internally powered by the DC battery pack 100 itself, or can be designed to be externally AC or DC powered. An internal temperature sensor 138 can be provided in the battery pack 100 and connected to the power and control system 122 to aid in controlling the heating output of the heating elements 132. The battery pack 100 may also utilize external temperature sensors and/or receive weather data from an external source for use in controlling the output of the heating elements 132. In some examples, the power and control system 122 activates the heating elements 132 when internal temperatures within the battery pack 100 fall below the minimum discharge or charge operating temperatures, as sensed by sensor 138. In some examples, the heating elements 132 can be switched on by a relay on a board of the power and control system 122, for example within the head module 124.

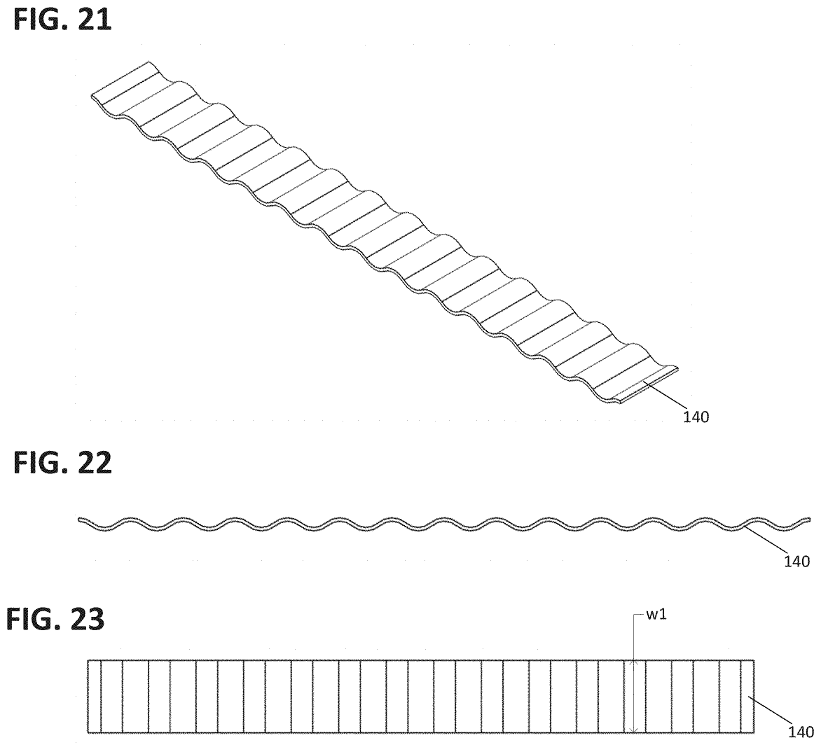

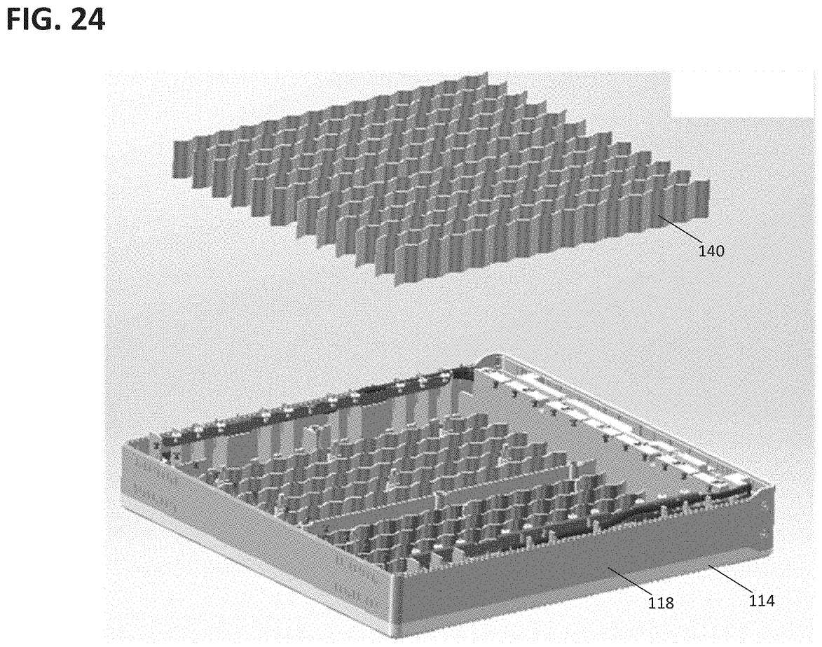

Referring to FIGS. 21 to 23, a separator element 140 is presented. In general terms, the separator element 140 is provided with the same width w1 dimension as the heating elements 132. Accordingly, where a battery pack 100 is desired without a heating arrangement 130, multiple separator elements 140 can be installed in place of the heating elements 132 such that separation and support of the battery cells 102 is maintained. In one aspect, each of the separator elements 140 can be characterized as an insert component and can be further characterized as inactive component, meaning that no heating arrangement or functionality is provided with the separator element 140. Such an arrangement is partially illustrated at FIG. 24 where twelve separators 140 are provided in lieu of the heating elements 132. Using separators 140 where heating is not required also reduces the cost of the battery pack 100 for packs not provided with heating. In some examples, the separators 140 are formed from a plastic material and are pre-formed with an undulating or serpentine shape. In some examples, the separators 140 are formed from a flexible material, such as a plastic material, and conform to the space defined between the battery cells 102.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A battery pack comprising:
a) a first battery holder frame and a second battery holder frame;
b) a plurality of battery cells secured between the first and second battery holder frames; and
c) at least one electric heating element secured between and secured by the first and second battery holder frames, the at least one electric heating element being in direct contact with each of the plurality of battery cells.

2. The battery pack of claim 1, wherein the heating element is powered by the plurality of battery cells.

3. The battery pack of claim 1, wherein the battery pack includes a battery management system controlling charging and discharging of the battery pack, wherein the battery management system further controls the heating element operation.

4. The battery pack of claim 1, wherein the battery holder frame includes a first plurality of cylindrically-shaped sidewalls securing the battery cells at one end and a second plurality of cylindrically-shaped sidewalls securing the battery cells at the opposite end.

5. The battery pack of claim 4, wherein the heating element is located between an first inner end of the first plurality of cylindrically-shaped sidewalls and a second inner end of the second plurality of cylindrically-shaped sidewalls.

6. The battery pack of claim 4, wherein each of the first and second holders include opposing separator walls extending along sides of the battery cells and forming a gap therebetween.

7. The battery pack of claim 1, wherein the heating element includes a plurality of heating elements.

8. The battery pack of claim 1, wherein some of the plurality of battery cells are oppositely arranged with respect to others of the plurality of battery cells.

9. The battery pack of claim 1, wherein the heating element is a single continuous heating element.

10. A battery pack comprising:
a) a first battery holder frame including a first plurality of cylindrically-shaped sidewalls defining a first plurality of openings;
b) a second battery holder frame including a second plurality of cylindrically-shaped sidewalls defining a second plurality of openings;
c) a plurality of battery cells secured between the first and second battery frames, such that a first end of each of the plurality of battery cells is received in one of the first plurality of openings and such that a second end of each of the plurality of battery cells is received in one of the second plurality of openings;
d) an interstitial space extending between the plurality of battery cells and between a first inner end of the first plurality of cylindrically-shaped sidewalls and a second inner end of the second plurality of cylindrically-shaped sidewalls; and
e) a separator that is separately formed from the first and second battery holder frames, the separator being positioned within the interstitial space and having a first side in contact with at least one of the plurality of battery cells and a second side in contact with at least one other of the plurality of battery cells, wherein the separator is one of an electric heating element and an inactive insert component.

11. The battery pack of claim 10, wherein the first inner end is in contact with a first side edge of the separator and the second inner end is in contact with a second side edge of the separator.

12. The battery pack of claim 10, wherein the separator is in contact with each of the plurality of battery cells.

13. The battery pack of claim 10, wherein the first battery holder frame further includes a plurality of first support wall extensions extending from at least some of the first plurality of openings in a direction towards the second battery holder frame.

14. The battery pack of claim 13, wherein the separator extends between the plurality of first support wall extensions such that each battery cell is supported on one side by the at least one heating element and on an opposite side by one of the plurality of first support wall extensions.

15. The battery pack of claim 14, wherein the second battery holder frame further includes a second plurality of support wall extensions extending from at least some of the second plurality of openings in a direction towards the first battery holder frame, wherein each battery cell is supported on one side by one of the plurality of second support wall extensions

16. The battery pack of claim 11, wherein the separator is a an electric heating element and the battery pack further includes a power and control system configured to charge and discharge the battery cells and to control power delivered to the at least one heating element.

17. A method of assembling a battery pack comprising:
a) providing an enclosure;
b) installing a first holder within the enclosure;
c) inserting a plurality of battery cells within the first holder;
d) inserting a heating element or an inactive insert component between the battery cells;
e) installing a second holder over the plurality of batteries and the heating element or inactive insert component such that the heating element or inactive insert component is clamped between the first and second holders; and
f) covering the enclosure.

18. The method of claim 17, wherein the inserting a heating element or inactive insert component step includes inserting the heating element or inactive insert component such that the at least one heating element or inactive insert component contacts each of the plurality of battery cells.

19. The method of claim 17, wherein the inserting a heating element or inactive insert component step includes inserting the heating element or inactive insert component between the plurality of battery cells along every other row of battery cells.

20. The method of claim 17, wherein after the step of installing a second holder, the heating element or inactive insert component is in direct physical contact with the first and second holders.
